(19) United States
(12) Patent Application Publication
(10) Pub. No.: US 2026/0335834 A1
(43) Pub. Date: Oct. 29, 2026

(54) MULTI-ELEMENT FILTRATION VESSEL

(71) Applicant: DDP SPECIALTY ELECTRONIC MATERIALS US, LLC, Wilmington, DE (US)

(72) Inventors: Steven JONS, Edina, MN (US); Bin HE, Huzhou (CN); Bie LI, Huzhou (CN); Liangzhou FAN, Huzhou (CN)

(21) Appl. No.: 19/123,441

(22) PCT Filed: Oct. 23, 2023
(86) PCT No.: PCT/US2023/077526

§ 371 Date: Apr. 23, 2025

(30) Foreign Application Priority Data
Nov. 21, 2022 (WO) PCT/CN2022/133190

(51) Int. Cl. B01D 63/00

(52) U.S. Cl. CPC B01D 63/00; B01D 2313/21; B01D 2315/06

(57) ABSTRACT

A multi-element filtration vessel contains multiple filtration elements. The elements have cylindrical housings and an annular header. At least a portion of the annular header surrounds the cylindrical housings at one end. The annular header has a periodically varying cross-sectional width and thickness such that the annular header has alternating thinner and thicker regions. The elements are packed with thinner sections of the header aligned. This allows for close packing of the elements without unduly compromising the mechanical strength of the headers.

### FIELD OF THE INVENTION

This invention relates to multi-element filtration vessels.

### BACKGROUND OF THE INVENTION

Multi-element filtration vessels are used widely in water treatment facilities to purify water. Semi-permeable membranes are assembled within elements, which are mounted vertically in an array within the vessel. A feed fluid is fed through the elements, where it is separated by the membranes into a concentrate and a permeate. A mixing gas is usually introduced into the vessel at a point below the elements. The mixing gas can perform several useful functions. When the membrane is a hollow fiber type, gas bubbles provide buoyancy, assisting with the transfer of the feed fluid between fibers or through the capillaries in the fibers. The mixing gas also can perform a cleaning function, and improve fluid mixing.

The filtration elements generally include a cylindrical housing which contains the membrane(s). A header is fitted onto one end of the cylindrical housing. The header is an annular piece that fits over the cylindrical housing. Its outside cross-sectional dimensions are larger than the outside dimensions of the cylindrical housing. The larger diameter means that fewer filtration elements can be packed within a pressure vessel of a given size. Increasing the number of filtration elements within a vessel increases its capacity. For large installations, this can mean that fewer filtration vessels are required and/or that the cost of vessels may be spread over a larger number of filtration elements. This would greatly reduce both equipment and operating costs. An improved ratio of filtration element area to vessel cost may also be obtained through more efficient packing. For instance, the existence of edge effects within a vessel of filtration elements can enable non-regular packing geometries to exceed the efficiency of close-packed geometries.

Filtration elements are typically cylindrical in shape, and the headers used with them are also generally cylindrical. Making the walls of the headers thinner can reduce the overall cross-section of the filtration element, but in doing so the header can be weakened to the point that it can no longer tolerate the physical stresses incurred during handling, transportation and use. Thus, the header walls tend to be rather thick, thereby increasing the cross-sectional dimensions of the filtration elements and limiting how tightly the elements can be packed within the pressure vessel.

### SUMMARY OF THE INVENTION

This invention addresses that problem by providing a filtration element comprising
a) a cylindrical housing having an exterior diameter, the cylindrical housing enclosing an interior portion of the filtration element, the cylindrical housing having opposing first and second ends;
b) at least one filtration membrane disposed within the interior portion of the filtration element;
c) one or more openings for admitting a feed fluid through at least one of the opposing first and second ends of the cylindrical housing and into the interior portion of the filtration element;
d) an annular header including a surrounding section that surrounds one of the opposing ends of the cylindrical housing, the surrounding section having a periodically varying cross-sectional width and thickness such that the surrounding section of the annular header has alternating thinner and thicker regions, and
e) separate openings for removing permeate and concentrate from the filtration element.

Because of the periodically varying cross-sectional width, the surrounding section of the annular header has alternating thinner regions and thicker regions, the thinner regions being spaced periodically (and preferably regularly) around the circumference of the surrounding section of the annular header. The thinner regions can be made quite small, such as 1-3 mm or less in thickness, because mechanical strength is provided by the alternating thicker regions. When packed into a multi-element filtration apparatus, thinner regions of the annular headers are aligned, allowing adjacent filtration elements to be packed more closely together.

The invention is also a multi-element filtration apparatus, the apparatus comprising
a) a pressure vessel having a cylindrical shell;
b) multiple filtration elements of the invention arranged vertically inside the cylindrical shell of the pressure vessel, wherein adjacent filtration elements are aligned along thinner regions of the sections of the annular headers surrounding the respective permeate ends of the cylindrical housings of the adjacent filtration elements;
a feed inlet port for introducing a feed fluid into the pressure vessel; a permeate discharge port for discharging from the pressure vessel a permeate produced by the multiple filtration elements, and a concentrate discharge port for discharging from the pressure vessel a concentrate produced by the multiple filtration elements.

### BRIEF DESCRIPTION OF THE DRAWINGS

FIG. 1 is a front view, in section, of a first embodiment of a multi-element filtration apparatus of the invention.

FIG. 2 is a front view, partially in section, of a filtration element of the invention.

FIG. 3 is an isometric view of one end of a filtration element of the invention with attached end cap.

FIG. 4 is an isometric view of an annular header for use in the invention.

FIG. 5 is an isometric sectional view of an annular header for use in the invention.

FIG. 5A is an isometric sectional view of a top section of a filtration element of the invention.

FIG. 6 is a top sectional view of an annular header for use in the invention.

FIG. 7 is a side view of an annular header for use in the invention.

FIG. 7A is a rotated view of the annular header shown in FIG. 7.

FIG. 8 is a top view of an arrangement of filtration elements of the invention.

FIG. 9 is a top view of a module pack within a pressure vessel with support plate.

FIG. 10 is a front view, in section, of a second embodiment of a filtration apparatus of the invention.

### DETAILED DESCRIPTION OF THE INVENTION

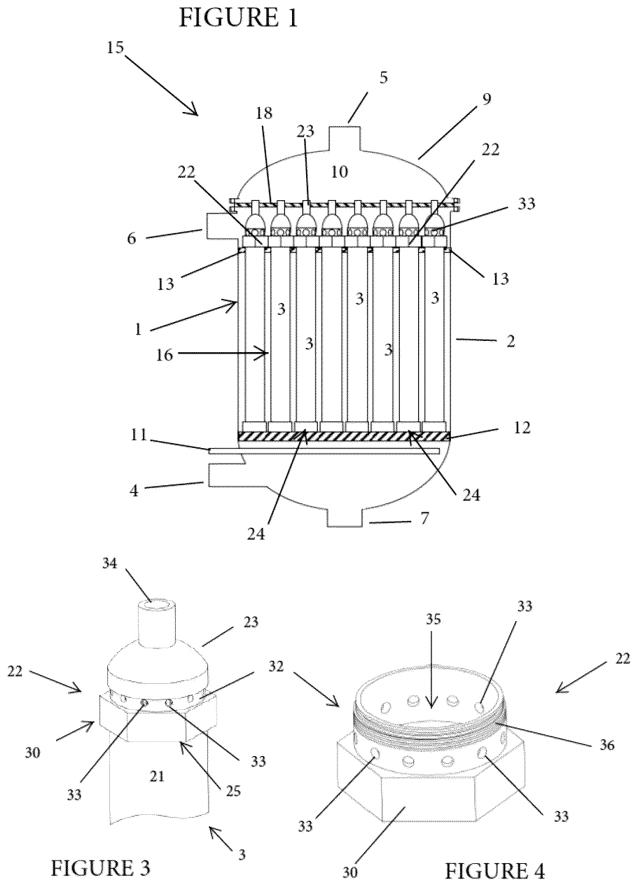

Turning to FIG. 1, multi-element filtration apparatus 15 includes pressure vessel 1, which in the embodiment shown includes shell 2 and removable lid 9. Preferably, shell 2 is cylindrical and pressure vessel 1 is suitable for operation with inside pressures exceeding at least two bars above the outside pressure. A filtration chamber 16 is surrounded by the shell 2 and pressure plate 18. Filtration elements 3 are disposed vertically within filtration chamber 16. In this embodiment filtration elements 3 are aligned and supported by at least one of pressure plate 18, support plate 13 and bottom support plate 12. Support plate 13 as shown includes openings for receiving filtration elements 3 such that headers 22 rest on support plate 13.

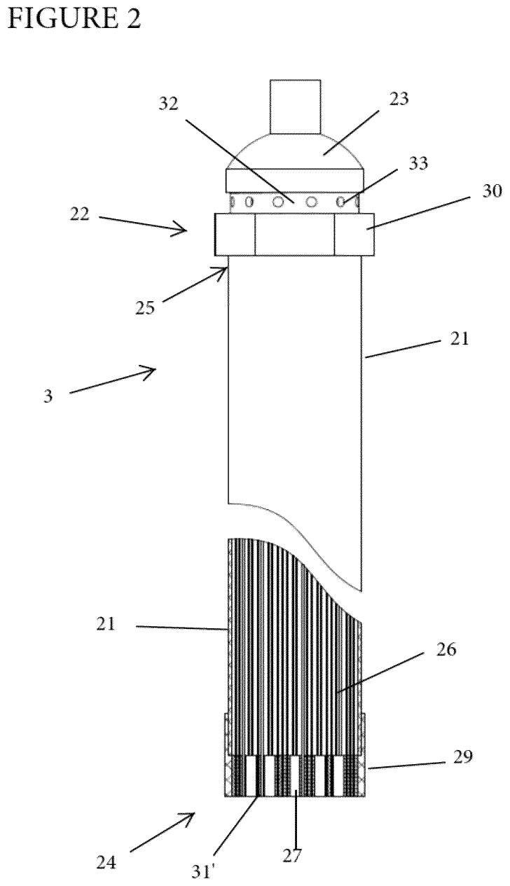

In the embodiment shown in FIG. 1, feed fluid to be treated is introduced under pressure into multi-element filtration apparatus 15 through inlet port 4, where it passes through openings in bottom support plate 12 and enters filtration elements 3 through holes 27 in first ends 24 of filtration elements 3 (see FIG. 2). Filtration elements 3 contain one or more membranes 26 (FIG. 2), which allow a portion of the feed fluid to pass through, thereby producing permeate (or filtrate) and a concentrate (or reject) stream containing a small portion of the feed fluid plus materials that do not pass through the pores of the membrane.

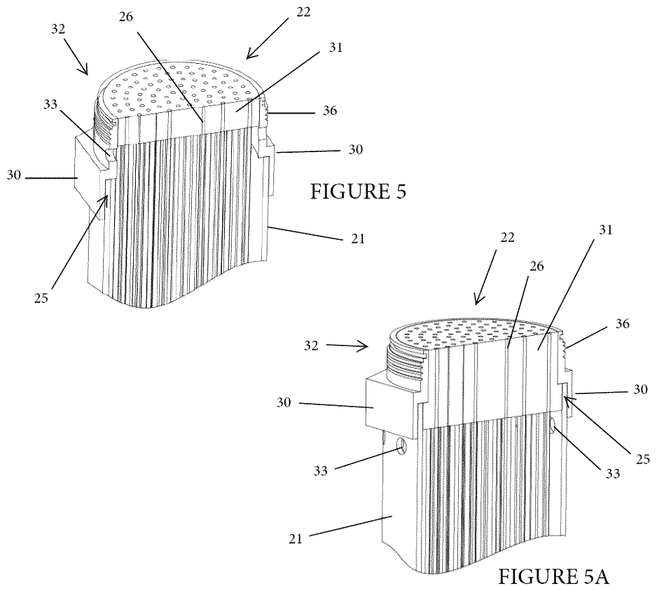

In the embodiment shown in FIGS. 1, 3 and 4, concentrate is withdrawn from filtration elements 3 through openings 33 in annular header 22 and withdrawn from pressure vessel 1 through concentrate port 6. In alternative embodiments, instead of or in addition to openings 33, openings for withdrawing concentrate from filtration elements 3 may be present within the cylindrical housing 21. In either case, permeate passes through central opening 35 of annular header 22 into collection chamber 10 of pressure vessel 1, from which it is removed via permeate port 5. In the particular embodiment shown, optional end cap 23 is mounted onto annular header 22 and forms a conduit for permeate exiting central opening 35 into collection chamber 10, permeate flowing into collection chamber 10 through outlet 34 of end cap 23. As shown, end cap 23 extends through pressure plate 18. Alternatively, annular header 22 may be in direct fluid communication with collection chamber 10 through openings in pressure plate 18. Collection chamber 10 during operation usually is maintained at a lower pressure than filtration chamber 16. Filtration element 3 and pressure vessel 1 can alternatively be designed such that concentrate passes through outlets 34 and permeate is removed via port 6. This can be done, for example, by operating in an inside-out mode of operation with both top and bottom ends of the hollow fiber membranes being open.

Optional aerator 11 provides a mixing gas that is introduced into first ends 24 of filtration elements 3. Introducing both gas and feed fluid from the bottom end of the filtration element 3 can induce an upward force on feed fluid to drive concentrate towards openings 33. Openings 33 for concentrate may be in the cylindrical housing 21 or the header 22, but these openings 33 are separated from the permeate outlet 34 by a seal, such a layer of potting 31, as shown in FIG. 5.

Although the embodiment shown in FIG. 1 is designed to operate with feed fluid being introduced from the bottom and concentrate and permeate being removed from the top, in alternative embodiments multi-element filtration apparatus 15 can be configured to operate with feed fluid being introduced into the top and concentrate being withdrawn from the bottom. Additionally, the embodiment shown in FIG. 1 can alternatively be designed with openings in support plate 13 that allow concentrate to drain into filtration chamber 16, from which it can be removed through an appropriate port.

Turning to FIG. 2, filtration element 3 includes cylindrical housing 21, which encloses an interior space, in which one or more filtration membranes 26 are disposed. Filtration element 3 has opposing first and second ends 24 and 25 at opposing ends of cylindrical housing 21. During normal operation a feed fluid is introduced into first end 24 through inlet holes 27, and permeate and concentrate flow out of second end 25 into annular header 22. In the embodiment shown in FIG. 2, inlet holes 27 pass through the lower end of a potting layer 31′. Inlet holes 27 may alternatively pass through optional collar 29 or through a location on the cylindrical housing 21, below potting layer 31′. Optional collar 29 may cover first end 24. Optional end cap 23 is mounted on annular header 22; in the particular embodiment shown, end cap 23 is in fluid communication with annular header 22 and collection chamber 10 of pressure vessel 1, to allow permeate to flow out of filtration element 3 and, in the embodiment shown FIG. 1, into collection chamber 10.

Annular header 22 is in the general shape of a ring with a central opening 35. That portion of central opening 35 that surrounds cylindrical housing 21 is generally circular to correspond to the exterior shape of cylindrical housing 21.

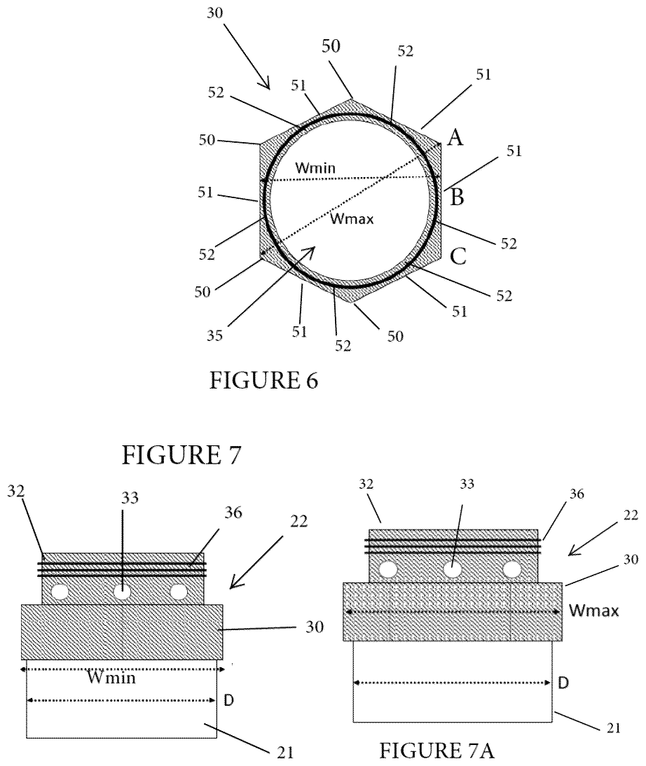

Annular header 22 includes a surrounding section 30 that surrounds an end (as shown, second end 25) of cylindrical housing 21. Surrounding section 30 has a periodically varying cross-sectional width, as shown in more detail in FIG. 6. Starting at any arbitrary point A on the outer surface of surrounding section 30 of annular header 22, the cross-sectional width of surrounding section 30 changes in a periodic manner around the circumference of surrounding section 30. Thus, in FIG. 6, surrounding section 30 has a cross-sectional width Wₘₐₓ at point A. Moving clockwise around surrounding section 30 as shown in FIG. 6, the cross-sectional width first decreases, reaching Wₘᵢₙ<Wₘₐₓ at point B, then increases to again attain Wₘₐₓ at point C, and thereafter periodically decreases and increases between Wₘᵢₙ and Wₘₐₓ until one returns to starting point A. This produces alternating thinner regions 52 and thicker regions 53, reaching relative minima at points such as point B, where the width decreases to Wₘᵢₙ. Thinner regions 52 are spaced periodically (and preferably regularly) around the circumference of section 30 of annular header 22. The periodic variation in the thickness of surrounding section 30 produces relative minima, which preferably appear at repeating intervals of 30 to 120 degrees, and most preferably at repeating intervals of 60 degrees.

Thinner sections 52 may have thicknesses, at the thinnest point, in the range of, for example 0.5 to 3 mm. Thicker sections 53, at their thickest point, may have thicknesses, for example, 1.4 to 5 times the minimum thickness of thinner sections 52, such as, for example, from 1 to 15 mm, especially 2 to 8 mm.

In the particular embodiment shown in FIGS. 3-7A, surrounding section 30 of annular header 22 has a preferred generally regular hexagonal outside cross-sectional shape. Vertices 50 may be rounded or beveled, if desired, rather than forming sharp points as shown in FIGS. 3-7A. Sides 51 of surrounding section 30 preferably are flat as shown in FIG. 5. Alternatively, surrounding section 30 may have any arbitrary number of sides, ranging from as few as three (it being generally triangular in cross-section in that case), four, or five, or as many as, for example, 12, 10 or 8 sides.

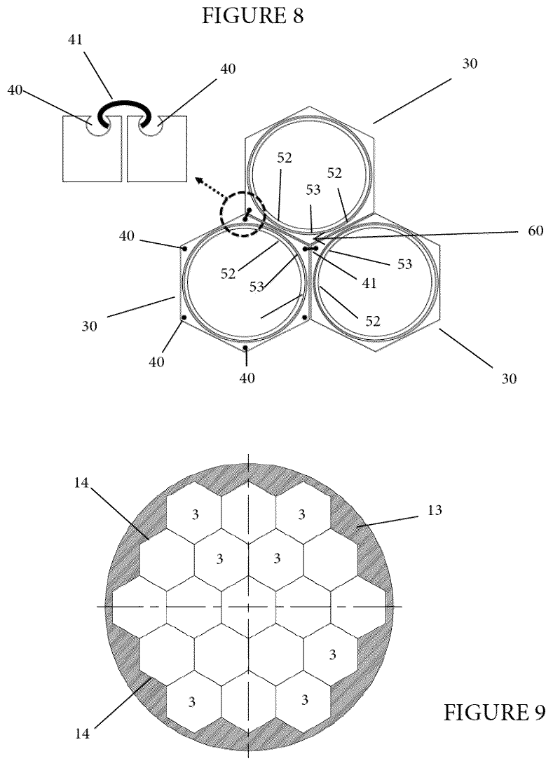

At all points about the circumference of filtration element 3, surrounding section 30 preferably has the largest cross-sectional width of any component of filtration element 3. Especially at points about the circumference of the filtration element 3 corresponding to regularly-spaced relative minima in the surrounding section 30, Wₘᵢₙ is preferably equal to or greater than the cross sectional width of each of the cylindrical housing 21, any optional collar 29, and any end cap 23. Referring to FIGS. 7 and 7A, the minimum width Wₘᵢₙ of surrounding section 30 of annular header 22 is equal to or greater than the cross-sectional width D of cylindrical housing 21, and the maximum width Wₘₐₓ of surrounding section 30 is greater than cross-sectional width D. End cap 23 as well as any collar 29 or other components as may be present, have a minimum width that is less than or equal to Wₘᵢₙ and a maximum width that is preferably no greater than Wₘᵢₙ. Preferably, at any point about the circumference of filtration element 3, any collar 29 and end cap 23 have a cross-sectional width equal to or less than that of the corresponding (at the same radial position) surrounding section 30 of annular header 22 at that point. Collar 29, when present, may have a periodically varying cross-sectional width as described with regard to surrounding section 30 of annular header 22.

Each membrane 26 may be, for example, a microfiltration membrane, ultrafiltration membrane, a nanofiltration membrane or a reverse osmosis membrane. Most preferred is an ultrafiltration membrane. In a preferred embodiment, the membranes take the form of hollow fiber membranes, but they can be spiral wound or have other configurations if desired.

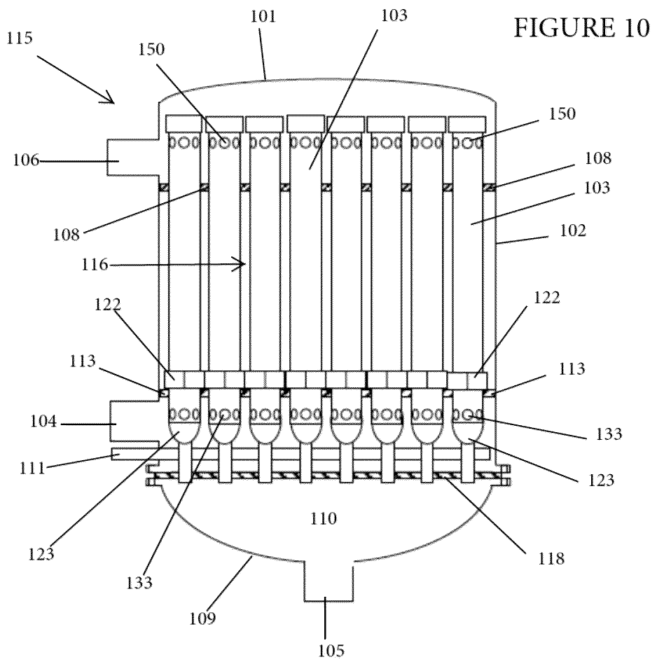

The preferred hollow fiber membranes are potted within filtration element 3, typically at both opposing ends (24, 25) of filtration element 3. The capillary openings of hollow fiber membranes are open on at least one end of the filtration element 3. In certain embodiments adapted for an outside-to-inside mode of permeating operation, capillary openings may be open on both ends, but they are preferably closed off at one end. Capillaries may be blocked at the first end 24, such as by being buried within the potting, and capillaries may be open and extend through the potting at the opposing second end 25 to allow permeate to exit the element. Referring to the configuration illustrated in FIG. 2, a potting layer 31′ seals the capillaries of hollow fiber membranes 26, but the potting layer 31′ also contains inlet holes 27 that pass through the potting layer 31′ and allow feed fluid to enter the filtration element 3. In other configurations (e.g., FIG. 10), capillary openings may be closed off at the second end 25, with open capillaries extending through the potting at the first end 24.

Permeate and concentrate are removed from the filtration element 3 at separate openings. In preferred embodiments with outside-to-inside permeation through hollow fibers, the permeate is removed from open capillaries of hollow fibers at either the top or bottom of the filtration element 3. In filtration elements adapted for inside-to-outside permeation, the capillary openings are generally open through pottings on both ends of the filtration element, allowing permeate to be removed from openings such as openings 33 of annular header 22, or other openings in cylindrical housing 21.

In the embodiments shown in FIGS. 5 and 5A, hollow fiber membranes 26 are potted at one end within header 22. In this particular embodiment, header 22 includes optional annular extension 32 that extends past second end 25 of cylindrical housing 21. As shown, membranes 26 may be sealed within a potting layer 31 that is located within annular extension 32, extending through potting layer 31 and being in fluid communication with collection chamber 10 via optional end cap 23. In the embodiment shown in FIG. 5, openings 33 are provided in annular header 22, between potting layer 31 and second end 25 of cylindrical housing 21, for removing concentrate (in the preferred outside-in mode of operation) or permeate (in the less preferred inside-out configuration). In the embodiment shown in FIG. 5A, openings 33 for removing permeate or concentrate from the filtration element instead are provided through cylindrical housing 21.

In some embodiments, hollow fiber membranes 26 are potted within surrounding section 30 of annular header 22, and/or within cylindrical housing 21, with appropriately located openings below the potting for removing concentrate or permeate, as the case may be.

Annular header 22 may include annular extension 32 even in cases in which membranes 26 do not extend into annular header 22 or past surrounding section 30 of annular header 22. For example, annular extension 32 may serve as a mounting region for optional end cap 23.

At locations radially aligned with thin regions (corresponding to relative minimums in thickness of the surrounding section 30), the annular extension 32 preferably has a cross-sectional width that is no greater than the minimum width Wₘᵢₙ of surrounding section 30 of annular header 22. Preferably, annular extension 32 has a smaller cross-sectional width, at all points around the circumference of filtration element 3, than that of surrounding section 30 of annular header 22. Annular extension 32 preferably has a circular outer perimeter having a diameter less than or equal to the minimum cross-sectional width of surrounding section 30 of annular header 22. Similarly, any end cap 23 preferably has a cross-sectional width, at all points around the circumference of filtration element 3, equal to or less than that of surrounding section 30 of annular header 22.

Optional end cap 23 is hollow and preferably includes at least one outlet 34 which is in fluid communication with both annular header 22 and collection chamber 10, thereby forming a fluid passageway between them.

End cap 23 preferably is removably mounted onto annular header 22, as this allows end cap 23 to be removed from annular header 22 to, for example, perform cleaning and/or maintenance (e.g., sealing of broken fibers). In the embodiment shown, annular extension 32 of annular header 22 includes threading 36 on its exterior surface. In such a case, reciprocal threading is provided on the mating interior surface of end cap 23. In another embodiment, annular extension 32 includes threading 36 on its interior surface and reciprocal threading is provided on the mating exterior surface of the end cap 23. Other mounting apparatus may be provided instead of or in addition to threading, such as groove and ridge mounts, various types of snap mounts, and the like.

Multiple filtration elements 3 of the invention are arranged vertically inside shell 2 of pressure vessel 1 to form a module pack. A module pack may contain, for example, 2 to 150 or more filtration elements 3, with 55 to 131 being an especially useful number of elements for many applications. In other preferred embodiments, the number of filtration elements 3 within a module pack may be selected from 55, 61, 73, 85, 91, 97, 119, or 131.

FIGS. 8 and 9 illustrate a suitable packing mode using preferred filtration elements 3 that have a cylindrical housing 21 and header 22 in which surrounding section 30 has the shape of a regular hexagon. As shown in FIG. 8, adjacent filtration elements 3 are aligned along one side of surrounding sections 30 of their respective annular headers 22. The aligned sides of the respective surrounding sections 30 of annular headers 22 are thinner regions 52 of the respective headers. Thicker regions 53 reside within gaps 60 formed where two or more filtration elements 3 come together. This allows close packing of filtration elements 3, as packing density is determined by the width Wₘᵢₙ of surrounding section 30 of annular header 22. Thicker sections 53 provide mechanical strength to annular header 22. Note that a conventional header of circular cross-section, having a constant width and thickness, will typically need to be thicker than thinner section 52 to provide the requisite mechanical properties. This increased thickness increases the spacing between elements and reduces the number of elements that can be packed within a given volume.

Module packs comprising filtration elements of the invention typically have an irregular outer periphery, as shown in FIG. 9. In some embodiments, support plate 13 occupies some or all of the space between the irregular outer periphery of the module pack and shell 2, or otherwise provides flow resistance between the irregular outer periphery of the module pack and shell 2. Support plate 13 may form a complete barrier to fluid flowing from above to below support plate 13, or may be a partial barrier having openings that allow fluid to flow from above to below support plate only at specified locations and/or at specified rates. Support plate 13 or any portion thereof may be canted or otherwise adapted to promote fluid flow in a particular direction or directions, such as toward a concentrate port such as concentrate port 6 in FIG. 1. In another embodiment, support plate 13 occupies some or all of the space between the irregular outer periphery of the module pack and shell 2.

FIG. 8 illustrates another optional but preferred feature, i.e., locking means for locking adjacent filtration elements together. In the particular embodiment shown, the locking means includes clips 41 and receiving notches 40, which are adapted to receive and hold clips 41. Other mechanical locking means include a variety of latches and/or clips. Magnetic locking means are also useful. The locking means preferably is adapted to be opened and re-closed to allow easy removal or unpacking of filtration elements from the module pack.

Multi-element filtration apparatus 15 may further include various auxiliary apparatus such as pumps, valves, seals, instrumentation, piping, ductwork and the like as may be desirable or useful.

The multi-element filtration apparatus of the invention is in general operable in the same way as conventional multi-element filtration apparatus. Flow of feed fluid within a filtration element 3 may be driven, up or down, based on an induced pressure differences. During operation of a pressure vessel as shown in FIG. 1, for example, a feed fluid may be introduced into pressure vessel 1 of multi-element filtration apparatus 15 via feed inlet port 4, and this alone could create an upward flow of feed fluid within the filtration element 3 if there were sufficient resistance to flow of feed fluid around the filtration elements 3. Such resistance may be provided, for instance, by the tight positioning of adjacent modules with annular headers. Alternatively, an upward movement of feed fluid within filtration elements 3 may be created by air bubbles. Referring again to FIG. 1, mixing gas is supplied into filtration element 3 by aerator 11, and the bubbles used to keep membranes 26 clean can also create an upward flow of feed fluid within the filtration element 3. Creation of an upward feed fluid flow within the filtration elements 3 is desired during operation, but it is also possible to create a downward flow of feed fluid by reversing the position of inlet port 4 and outlet port 6.

Upon entering interior portions of filtration elements 3, mixing gas and feed fluid travel upward through filtration elements 3, coming into contact with the filtration membranes 26, which separate the feed fluid into a permeate that passes through the membrane and a concentrate or reject that includes one or more concentrated materials that are rejected by the membrane and are thus prevented from passing through it. The permeate and concentrate are taken separately from at or near second ends 25 of filtration elements 3. In the preferred manner of operating the multi-element filtration apparatus 15 of FIG. 1, for example, permeate is removed from pressure vessel 1 via permeate port 5. Concentrate is removed from pressure vessel 1 via concentrate port 6. Mixing gas can be vented through concentrate port 6 or a separate air vent (not shown).

In the case of hollow fiber membranes operated with permeation in an outside-to-inside manner, the mixing gas and feed fluid are supplied to and contacted with the exterior surfaces of the hollow fiber membranes 26. A portion of the fluid passes through the hollow fiber membranes 26 and into their respective capillaries to produce the permeate, the concentrate in that case being that portion of the feed fluid and rejected materials that do not pass through and into the hollow fibers. The apparatus of the invention can also be operated in an inside-out manner, with feed fluid being fed into the capillaries.

In other embodiments, multi-element filtration apparatus 15 is designed for and operated with top-to-bottom flow of feed fluid, with feed fluid being introduced above filtration elements 3 and concentrate and permeate being removed from the bottom of filtration elements 3. The direction of feed fluid flow may be selected independent of whether permeate is removed from the top or bottom of a filtration element 3.

In FIG. 10, an alternate embodiment of multi-element filtration apparatus 115 includes pressure vessel 101, which in the embodiment shown includes shell 102 and removable lid 109. Preferably, shell 102 is cylindrical and pressure vessel 101 is suitable for operation with inside pressures exceeding at least two bars above the outside pressure. A filtration chamber 116 is surrounded by the shell 102 and pressure plate 118. Filtration elements 103 are disposed vertically within filtration chamber 116. In this embodiment filtration elements 103 are aligned by at least one of positioner 108 and support plate 113. Positioner 108 may provide alignment, mechanical support and/or function a flow restrictor to maintain pressure drops necessary for operation. Support plate 113 as shown includes openings for receiving filtration elements 103 such that headers 122 rest on support plate 113. In this embodiment, filtration elements are inverted compared to the FIG. 1 embodiment, with headers 122 at the bottoms of the elements as installed.

In operation, feed fluid enters pressure vessel 101 via feed inlet 104 and enters filtration elements 122 via openings 133. As before, optional aerator 111 supplies gas bubbles that enter openings 133 together with feed fluid to provide buoyancy. The capillaries of hollow fiber membranes in this particular embodiment are open at the bottom of filtration elements 103 and closed at the top. In an outside-to-inside mode of operation, a portion of feed fluid entering openings 133 passes through pores in the hollow fibers to produce permeate within the capillaries. With the geometry of FIG. 10, the permeate flows downward, through the header 122 and optional end cap 123 into collection chamber 110 and then out via permeate port 105. As before, pressure plate 118 separates filtration chamber 116 from collection chamber 110, which is at a lower pressure than filtration chamber 116. Concentrate is removed from the top end of filtration elements 103 via holes 150. In the particular embodiment shown, concentrate exiting holes 150 enters filtration chamber 116 and is removed from pressure vessel 101 via concentrate port 106.

The multi-element filtration apparatus of the invention is useful for filtering a wide variety of fluids, especially aqueous fluids such as groundwater, surface water, seawater, process streams from chemical operations and/or power generating stations, as well as many others. In a particular embodiment, the multi-element filtration apparatus is a seawater ultrafiltration and/or microfiltration apparatus, and can be used, for example, as a prefilter for preparing seawater for reverse osmosis to produce potable water.

Although the present invention has been described in terms of specific exemplary embodiments, it will be appreciated that various modifications and alterations might be made by those skilled in the art without departing from the spirit and scope of the invention as set forth in the following claims.

1. A filtration element comprising
a) a cylindrical housing having an exterior diameter, the cylindrical housing enclosing an interior portion of the filtration element, the cylindrical housing having opposing first and second ends;
b) at least one filtration membrane disposed within the interior portion of the filtration element;
c) one or more openings for admitting a feed fluid through at least one of the opposing first and second ends of the cylindrical housing and into the interior portion of the filtration element;
d) an annular header including a surrounding section that surrounds one of the opposing ends of the cylindrical housing, the surrounding section having a periodically varying cross-sectional width and thickness such that the surrounding section of the annular header has alternating thinner and thicker regions, and
e) separate openings for removing permeate and concentrate from the filtration element.

2. The filtration element of claim 1 wherein the thickness of the surrounding section of the annular header periodically varies to produce relative minima at regular intervals of 30 to 120 degrees.

3. The filtration element of claim 2 wherein the thickness of the surrounding section of the annular header varies periodically to produce relative minima at repeating intervals of 60 degrees.

4. The filtration element of claim 1 wherein the section of the annular header surrounding the outlet of the cylindrical housing has six flat exterior faces arranged regularly about the circumference of the section with vertices between each pair of adjacent flat exterior faces, the vertices optionally being curved or beveled.

5. The filtration element of claim 4 wherein the section of the annular header surrounding the outlet of the cylindrical housing has a regular hexagonal cross-section.

6. The filtration element of claim 1 wherein the at least one filtration membrane extends into the annular header and is potted within the annular header.

7. The filtration element of claim 6 wherein the at least one filtration membrane extends through the potting and is in fluid communication with a fluid collection region external to both the cylindrical housing and the annular header for receiving permeate.

8. The filtration element of claim 7 wherein the annular header further comprises an annular extension that extends past the surrounded end of the cylindrical housing, the at least one filtration membrane is potted within the annular extension, and the annular header has openings between the potting and the end of the cylindrical housing for removing concentrate from the annular header.

9. The filtration element of claim 8 wherein the annular extension has a circular outer perimeter having a diameter less than or equal to the minimum cross-sectional width of the surrounding section of the annular header.

10. The filtration element of claim 8 further comprising an end cap affixed to and in fluid communication with both the annular header and the fluid collection region.

11. The filtration element of claim 10 wherein the end cap is removably affixed to the annular extension of the annular header.

12. A multi-element filtration apparatus, the apparatus comprising
a) a pressure vessel having a shell;
b) a plurality of filtration elements of claim 1 arranged vertically inside the shell of the pressure vessel, wherein adjacent filtration elements are aligned along thinner regions of the surrounding sections of the annular headers of the adjacent filtration elements;
a feed inlet port for introducing a feed fluid into the pressure vessel; a permeate discharge port for discharging from the pressure vessel a permeate produced by the multiple filtration elements, and a concentrate discharge port for discharging from the pressure vessel a concentrate produced by the multiple filtration elements.

13. The multi-element filtration apparatus of claim 12 wherein the multiple filtration elements are removably mounted on the support.

14. The multi-element filtration apparatus of claim 13 wherein the support comprises a support plate within the pressure vessel, the support plate having openings for receiving filtration elements, and the annular headers rest on and are supported by the support plate.

15. The multi-element filtration apparatus of claim 12 further comprising one or more aerators for supplying a mixing

16. The multi-element filtration apparatus of claim 12 wherein the concentrate discharge port is located above the annular headers of the filtration elements.

17. The multi-element filtration apparatus of claim 12 wherein the multiple filtration elements form a module pack having an irregular outer periphery.

18. The multi-element apparatus of claim 17 wherein the annular headers rest on and are supported by a support plate, and the support plate provides flow resistance between the irregular outer periphery of the module pack and the shell.

19. The multi-element filtration apparatus of claim 18 further comprising locking means for locking adjacent filtration elements together.

20. The filtration element of claim 9, further comprising an end cap affixed to and in fluid communication with both the annular header and the fluid collection region, and optionally wherein the end cap is removably affixed to the annular extension of the annular header.
